(19) United States
(12) Patent Application Publication
(10) Pub. No.: US 2010/0033757 A1
(43) Pub. Date: Feb. 11, 2010

(54) Image Processing Device, Print Data Generating Method, and Recording Medium

(75) Inventor: Toshiki SAITO, Matsumoto-shi (JP)

Correspondence Address: HOGAN & HARTSON L.L.P., 1999 AVENUE OF THE STARS, SUITE 1400, LOS ANGELES, CA, 90067, US

(73) Assignee: SEIKO EPSON CORPORATION, Tokyo (JP)

(21) Appl. No.: 12/502,905

(22) Filed: Jul. 14, 2009

(30) Foreign Application Priority Data
Aug. 8, 2008 (JP) 2008-205187

(51) Int. Cl. G06F 3/12

(52) U.S. Cl. 358/1.15; G9B/3.052

(57) ABSTRACT

Provided is a print data generation method of generating print data, which is described by a predetermined printer description language and used in a predetermined printing apparatus, by using an image processing device. The method includes receiving first print data, which is described by the predetermined printer description language and generated by a device driver used for printing of the printing apparatus, from the device driver. In addition, the method also includes generating second print data, which is obtained by processing image correspondence data as data corresponding to at least portion of an image part of the received first print data.

### BACKGROUND

1. Technical Field

The present invention relates to a technique of adding or updating an image processing function for printing.

2. Related Art

Generally, a printing system in which a personal computer and a printing apparatus are connected to each other is known. In such a printing system, adding an image processing function for printing (such as an image processing for reverse printing or an image processing for ink saving) is realized only by updating the device driver (a printer driver) in the personal computer (refer to Japanese Unexamined Patent Application Publication No. 2005-335291).

In the case where the image processing function is added by updating the printer driver, the printer driver may be different for each type of the printing apparatuses. When the image processing function is added to various types of the printing apparatuses, it requires the updating of various printer drivers. This requires very complex work. In addition, when the added function is updated, further complex work is required.

### SUMMARY

An advantage of some aspects of the invention is to provide a technique capable of easily adding or updating the image processing function for printing.

The present invention can be realized by the following aspects.

According to a first aspect of the invention, provided is an image processing device for generating print data, which is described by a predetermined printer description language and is used in a predetermined printing apparatus. The device includes: a reception section for receiving first print data, which is described by the predetermined printer description language and generated by a device driver used for the printing of the printing apparatus, from the device driver; and a print data generation section for generating second print data, which is obtained by processing image correspondence data as data corresponding to at least portion of an image part of the received first print data.

According to the image processing device of the first aspect of the invention, the print data generation section generates the second print data which is obtained by processing image correspondence data as data corresponding to at least portion of an image part of the received first print data. By adding or updating such a print data generation section, it is possible to easily add or update the function (a function of image processing for printing) of processing the image correspondence data without updating the device driver of the printing apparatus.

In the image processing device, it is preferred that the printing apparatus be able to perform image formation by using dots of a plurality of sizes. In addition, it is also preferred that the first print data include data on the sizes of the dots assigned to pixels forming the image. In addition, it is also preferred that the print data generation section replace at least some of the dots of a predetermined size with dots of a size smaller than the predetermined size in the first print data.

With such a configuration, it is possible to suppress the amount of ink used in printing by replacing at least some of the dots of the predetermined size assigned to the pixels forming the image with the dots of a size smaller than the predetermined size.

In the image processing device, it is preferred that the printing apparatus be able to perform image formation by using dots of a first color having a plurality of sizes and by using dots of a second color having a plurality of sizes and having higher color density than the first color. In addition, it is also preferred that the first print data include data on the colors of the dots assigned to pixels forming the image. In addition, it is also preferred that the print data generation section replace at least some of the dots of the first color with the dots of the second color in the first print data.

With such a configuration, it is possible to adjust changes in the hue of the image at the time of printing by replacing at least some of the dots of the first color with the dots of the second color having a higher color density than the first color.

In the image processing device, it is preferred to include an edge information acquisition section which acquires information representing an edge portion of the image part from the first print data. In addition, it is also preferred that the printing apparatus be able to perform image formation by using dots of a plurality of sizes. In addition, it is also preferred that the first print data include data on the sizes of the dots assigned to pixels forming the image. In addition, it is also preferred that the print data generation section make sizes of dots at the edge portion uniform in the first print data.

With such a configuration, it is possible to reduce the unevenness of the edge portion and print the edge portion to be smooth by making the sizes of the dots, when in an ON state at the edge portion, uniform at the time of printing.

In the image processing device, it is preferred to include the device driver. In addition, it is also preferred that the reception section receive the first print data, which is generated by the device driver provided in the image processing device.

With such a configuration, it is possible to receive and process the print data received from the device driver in the image processing device.

According to the second aspect of the invention, provided is a print data generation method of generating print data, which is described by a predetermined printer description language and used in a predetermined printing apparatus, by using an image processing device. The method includes: -receiving first print data, which is described by the predetermined printer description language and generated by a device driver used for printing of the printing apparatus, from the device driver; and generating second print data, which is obtained by processing image correspondence data as data corresponding to at least portion of an image part of the received first print data.

According to the image processing device of the second aspect of the invention, the second print data is generated which is obtained by processing at least the image correspondence data of the first print data received from the device driver. Therefore, by adding or updating a functional section for executing a process of generating the second print data to the image processing device, it is possible to easily add and update the process (a process of the image processing for printing) of processing the image correspondence data without updating the device drivers for printing apparatuses.

According to the third aspect of the invention, provided is a computer program for generating, in a computer, print data described by a predetermined printer description language and used in a predetermined printing apparatus. The computer program prompts the computer to execute the functions of: receiving first print data, which is described by the predetermined printer description language and generated by a device driver used for printing of the printing apparatus, from the device driver; and generating second print data which is obtained by processing image correspondence data as data corresponding to at least portion of an image part of the received first print data.

According to the image processing device of the third aspect of the invention, the second print data, which is obtained by processing at least the image correspondence data of the first print data received from the device driver, is generated. Therefore, by adding or updating a functional section for executing a process of generating the second print data to the computer, it is possible to easily add and update the function (a process of the image processing for printing) of processing the image correspondence data without updating the device drivers for printing apparatuses.

### BRIEF DESCRIPTION OF THE DRAWINGS

The invention will be described with reference to the accompanying drawings, wherein like numbers reference like elements.

FIG. 1 is an explanatory diagram illustrating a configuration of a printer system using a personal computer as an image processing device according to a first example of the present invention.

FIG. 2 is an explanatory diagram illustrating difference between the example and a comparative example in a method of adding an image processing function for ink-saving printing.

FIG. 3 is an explanatory diagram schematically illustrating an image processing function for ink-saving printing according to a second example.

FIG. 4 is an explanatory diagram schematically illustrating a function executed by an additional function module according to a third example.

### DESCRIPTION OF EXEMPLARY EMBODIMENTS

### A. FIRST EXAMPLE

### A1. Apparatus Configuration

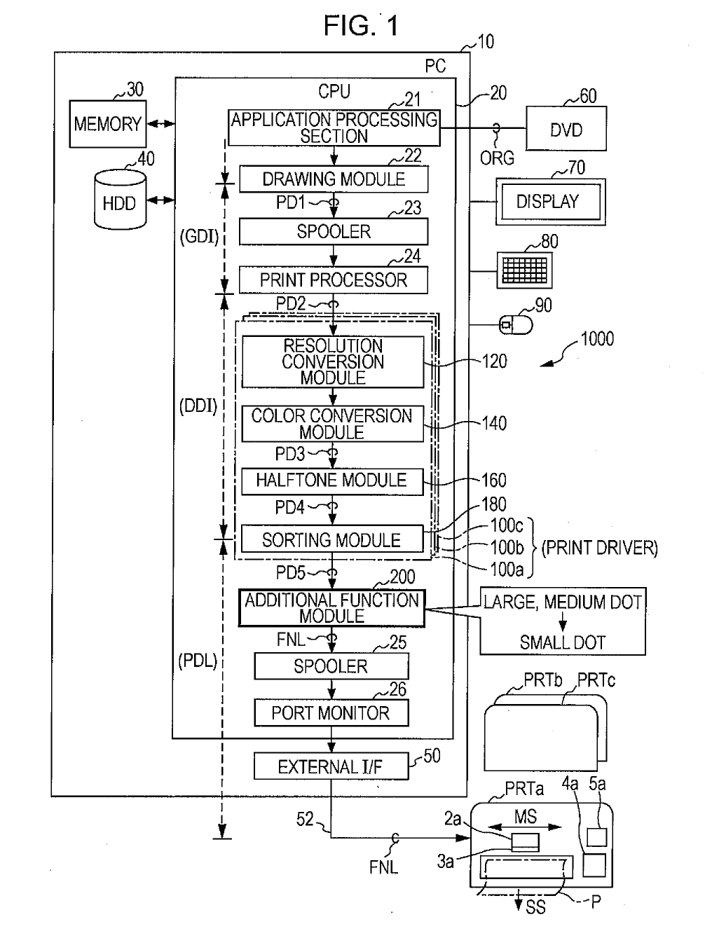

FIG. 1 is an explanatory diagram illustrating a configuration of a printer system using a personal computer as an image processing device according to a first example of the present invention. The printer system 1000 includes the personal computer (hereinafter, it is referred to as a “PC”) 10 and three printers PRTa, PRTb, and PRTc. All the three printers PRTa, PRTb, and PRTc are able to be connected to the PC 10. In the example shown in FIG. 1, the printer PRTa is connected to the PC 10 via a cable 52. Furthermore, for example, a USB (Universal Serial Bus) interface or a LAN (Local Area Network) interface such as IEEE 802.3 may be used as a connection interface between the PC 10 and the printers PRTa, PRTb, and PRTc.

The printer PRTa includes: a mechanism (not shown in the drawing) for transporting a sheet P by using a sheet feeding motor; a mechanism (not shown in the drawing) for reciprocating a carriage 2a in the transporting direction (a sub-scanning direction) SS of the sheet P and in a direction (a main scanning direction) MS perpendicular thereto by using a carriage motor; a printing head 3a, which is mounted on the carriage 2a, for ejecting ink and forming dots; a P-ROM 4a containing various setting data; and a CPU 5a for controlling the sheet feeding motor, the carriage motor, the printing head 3a, and a P-ROM 4a. The printer PRTa receives print data FNL from the PC 10, and performs printing by forming dots of cyan (C), magenta (M), yellow (Y), black (K), light cyan (LC), and light magenta (LM) on a printing medium in accordance with the print data FNL. In this case, the printer PRTa is able to form dots of three sizes of large, medium, and small. The difference in the size of the dots can be made, for example, as follows. In a configuration in which the printer PRTa ejects inks of the various colors by driving piezo elements, the dots of different sizes are formed by changing driving signals of the piezo elements to change the amount of ejected ink.

In this case, the printers PRTa to PRTc are each different types of printers. Accordingly, the printer drivers used to perform printing for the printers are different from each other. However, the printers PRTa to PRTc are able to perform printing by analyzing the print data described by the same printer description language (PDL). Furthermore, the interior configurations of the printers PRTb and PRTc are the same as that of the printer PRTa.

The PC 10 includes a CPU 20, a memory 30, a hard disk drive 40, and an external interface section 50. Further, the PC 10 is connected with a DVD drive 60 and input and output devices of a display 70, a keyboard 80, and a mouse 90.

The CPU 20 functions as an application processing section 21 by executing various programs stored in the memory 30 under a predetermined operating system. Likewise, the CPU 20 functions as various functional sections of a drawing module 22, a spooler 23, a print processor 24, three printer drivers 100a, 100b, and 100c, an additional function module 200, a spooler 25, and a port monitor 26. In the following description, Windows (Registered Trademark) of Microsoft Co. is used as an example of the predetermined operating system.

The printer driver 100a is a printer driver for the printer PRTa, and includes a resolution conversion module 120, a color conversion module 140, a halftone module 160, and a sorting module 180. Likewise, the printer driver 100b is a printer driver for the printer PRTb, and the printer driver 100c is a printer driver for the printer PRTc. In addition, these two printer drivers 100b and 100c have the same configuration as the above-mentioned printer driver 100a.

The additional function module 200 is for adding an image processing function for printing in the printer system 1000. As the image processing function, the present example adopts an image processing function for achieving printing (hereinafter, it is referred to as “ink-saving printing”) in which the amount of ink used in printing is reduced as compared with a case of normal printing (printing under situation in which the additional function module 200 is not added). The additional function module 200 is a function module additionally installed after the three printer drivers 100a to 100c are installed on the PC 10 after shipping. The additional function module 200 is installed only once on the PC 10. Furthermore, the additional function module 200 can be installed as a filter driver or a function of a spooler 25. Further, the additional function module 200 corresponds to the reception section, the print data generation section, and the edge information acquisition section described in the claims.

### A2. Ink-Saving Printing Process

An application processing section 21 reads an original image data ORG formed of three color components of R (red), G (green), and B (blue) from the DVD drive 60 in accordance with user's instruction input from the keyboard 80 or the mouse 90. In addition, the application processing section 21 performs processing such as the retouch of the image on the original image data ORG in accordance with user's instruction. When receiving a printing instruction (for example, an instruction of performing printing by using the printer PRTa on the basis of the image data processed by the retouch and the like) from the user, the application processing section 21 sends the image data processed by the retouch and the like to the drawing module 22, and requests print data generation. The drawing module 22 generates print data PD1 of GDI (Graphics Device Interface) format described by a drawing function, and send the data to the spooler 23. The spooler 23 temporarily stores the print data PD1 in the hard disk drive 40. The print processor 24 converts the print data PD1 stored in the hard disk drive 40 into print data PD2 of DDI (Device Driver Interface) format, and send the data to the printer driver 100a.

In the printer driver 100a, the resolution conversion module 120 converts the resolution of the image data included in the print data PD2 into the resolution used when the printer PRTa performs printing. The color conversion module 140 performs, in printing of a color image, conversion (color conversion) of the image data, in which colors of the pixels are represented by tone levels of RGB, into image data in which the colors of the pixels are represented by tone levels of cyan (C), magenta (M), yellow (Y), black (K), light cyan (LC), and light magenta (LM), and generates print data PD3. Furthermore, the color conversion module 140 performs the above-mentioned color conversion by referring to a color conversion table (not shown in the drawing) which is a 3D look-up table stored in the memory 30.

The halftone module 160 performs a halftone processing on the image data represented by the tone levels of the colors (C, M, Y, K, LC, and LM) of the pixels in the print data PD3, thereby converting the print data PD3 into print data PD4. The print data PD4 includes image data (hereinafter, it is referred to as “dot data”) represented by ON/OFF for the large, medium, and small dots for each of the colors. By such halftone processing, for example, it is possible to adopt the known technique described in Japanese Unexamined Patent Application Publication No. 2005-269298.

The sorting module 180 sorts the print data PD4 in order of data to be transmitted to the printer PRTa, and converts the sorted data so as to output print data PD5 described by the predetermined printer description language (PDL). Furthermore, the print data PD5 corresponds to the first print data described in the claims. Further, the above-mentioned dot data, included in the print data PD5, corresponds to the image correspondence data described in the claims.

The additional function module 200 performs a conversion processing of replacing large and medium dots with small dots for each color when receiving the print data PD5, and generates the print data FNL which will be finally sent to the printer PRTa. Specifically, the additional function module 200 performs a conversion processing of turning off the large and medium dots which are in an ON state and turning on the small dots at the same position on the image data (the dot data) of the print data PD5. Furthermore, the print data FNL corresponds to the second print data described in the claims.

The spooler 25 temporarily stores the print data FNL in the hard disk drive 40.

The port monitor 26 sends the print data FNL to the external interface section 50 so as to send the data to a specified output location (the printer PRTa). The external interface section 50 functions as a terminal section of a connection interface such as USB (Universal Serial Bus), and transmits the print data FNL to the printer PRTa via the cable 52.

The printer PRTa performs printing on the basis of the received print data FNL as described above. Since all the large and medium dots are turned off in the print data FNL for each color, the large and medium dots are not formed during printing. As a result, the tone level of each color is not represented in the original image data ORG, but it is possible to perform printing where the amount of ink used is suppressed. Accordingly, for example, in the case where the test printing (a draft printing) is performed and when there is a need to roughly figure out contents of an image or the printing result, it is possible to suppress the amount of ink used by performing the ink-saving printing process mentioned above.

Furthermore, also in a case where, instead of the printer PRTa, the printer PRTb or PRTc performs printing, although the used printer driver is different, it is possible to perform printing in which the amount of the ink used is suppressed in the same procedure as the above-mentioned printing process. The reason is as follows: the formatting of the image data (dot data) in the print data are the same as that in the print data output from the printer drivers 100a to 100c, even though the print drivers are different from each other, are described by the same PDL, and the additional function module 200 is able to perform the above-mentioned dot conversion processing.

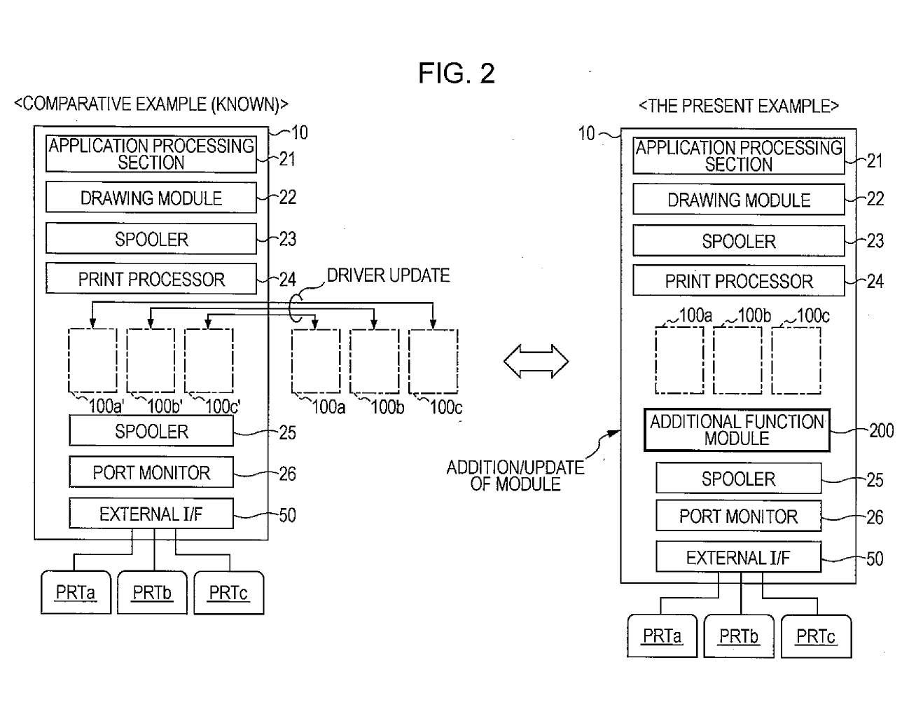

FIG. 2 is an explanatory diagram illustrating the difference between the present example of this invention and a comparative example of a method of adding an image processing function for the ink-saving printing. In FIG. 2, the left part schematically shows the existing method used as the comparative example, and the right part schematically shows the method of the example of this invention. In addition, in FIG. 2, the functional sections of the CPU 20 in the PC 10 are mainly described, but the memory 30, the hard disk drive 40, and the like have been omitted.

In the existing method used as the comparative example, the drivers for the printers PRTa to PRTc should be individually updated in order to achieve ink-saving printing. The reason is that, for example, the resolution conversion module 120 in the printer driver 100a (FIG. 1) is updated to perform the ink-saving printing by culling some pixels when the resolution conversion is performed. Alternatively, the color conversion module 140 is updated to perform the ink-saving printing by increasing the brightness and decreasing the chroma when the color conversion is performed. In the example of FIG. 2, the printer driver 100a is updated to a printer driver 100a′, the printer driver 100b is updated to a printer driver 100b′, and the printer driver 100c is updated to a printer driver 100c′. As described above, since all the printer drivers 100a to 100c should be updated, this work is very complex for a user.

Meanwhile, in the method according to the present example of this invention, it is possible to achieve ink-saving printing for each of the printers PRTa to PRTc if only the additional function module 200 is installed once in the PC 10. As a result, the user can easily add the image processing function for the ink-saving printing.

As described above, in the printer system 1000, the image processing function for printing may be added. In this case, the function is added only by installing one function module (the additional function module 200) once without updating the printer drivers 100a to 100c for the corresponding printers. Accordingly, it is possible to easily add the image processing function for each printer. Furthermore, since the additional function module 200 receives the print data PDS from the printer drivers 100a to 100c to perform the process, this work has no influence on the various processes in the printer drivers 100a to 100c. Further, even when the image processing function of the additional function module 200 is updated, updating is performed once on the additional function module 200. As a result, it is possible to easily update the image processing function.

### B. SECOND EXAMPLE

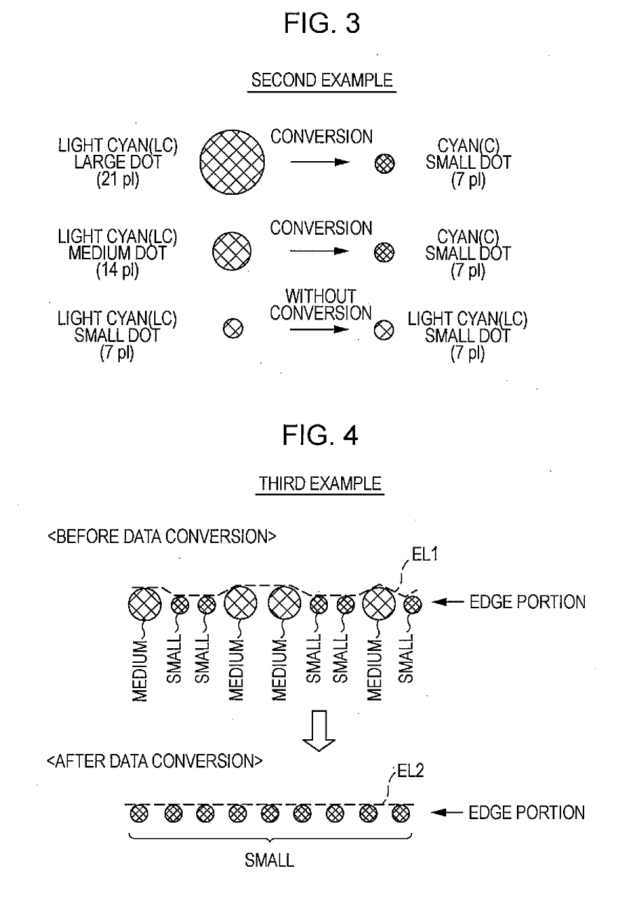

FIG. 3 is an explanatory diagram schematically illustrating an image processing function for ink-saving printing according to a second example. A printer system according to the second example is different from the printer system 1000 (FIG. 1) in that the detailed process contents in the additional function module 200 are different. However, the other configuration of the second example is the same as that of the first example.

Specifically, the additional function module 200 according to the second example performs a conversion processing of turning off the large and medium light cyan (LC) dots which are in the ON state and turning on the small cyan (C) dots at the same position when receiving the print data PD5 (FIG. 1). As shown in FIG. 3, when the amounts of ink used are compared, the amount of ink used for the large dot (LC) is 21 pl (picoliter), while the amount of ink used for the small dot (C) after conversion is 7 pl. In addition, the amount of ink used for the medium dot (LC) is 14 pl, while the amount of ink used for the small dot (C) after conversion is 7 pl. Accordingly, it is possible to suppress the amount of ink used by using the above-mentioned conversion. Further, in the case of reduction in the amount of ink used, light cyan (LC) is converted into cyan (C) which is deeper (has a higher density) in the same color. In such a manner, it is possible to adjust the optical density even when reducing the used amount of ink. Therefore, it is possible to suppress changes in hue caused by the change in the amount of ink. Furthermore, it may be possible to perform conversion from light magenta (LM) to magenta (M), instead of or in addition to the above-mentioned conversion from light cyan (LC) to cyan (C). Further, the color density is determined by a quantity or a type of color material, which is included in the ink, or the like, and can be evaluated by spectral characteristics, optical density, or the like.

The above-mentioned light cyan (LC) and light magenta (LM) correspond to the first color described in the claims. The cyan (C) and magenta (M) correspond to the second color described in the claims.

The printer system having the above configuration according to the second example can be made to have the same effect as the printer system according to the first example. In addition, it is possible to suppress changes in hue appearing when the ink-saving printing is performed.

### C. THIRD EXAMPLE

FIG. 4 is an explanatory diagram schematically illustrating a function executed by an additional function module according to a third example. A printer system according to the third example is different from the printer system 1000 (FIG. 1) in that the detailed process contents in the additional function module 200 are different. However, the other configuration of the third example is the same as that of the first example.

Specifically, the additional function module 200 according to the third example performs a conversion processing of detecting an edge portion of an image, turning off the large and medium dots which are in the ON state at the edge portion, and turning on the small dots at the same position when receiving the print data PD5 (FIG. 1). In the example of FIG. 4, the four medium dots, located at the edge portion before the data conversion, are turned off after the data conversion, and the small dots are turned on instead. In this case, since the medium and small dots are mixed with each other before the data conversion, the form of the. contour line EL1 of the edge portion is distorted. In contrast, since all the dots are small after the data conversion, the form of the contour line EL2 is made approximately linear. Accordingly, it is possible to make the edge portion smooth by reducing the unevenness of the edge portion while achieving the ink-saving printing.

The detection of the edge portion is performed by the application processing section 21 on the basis of the original image data ORG in the known method, and the detection result is stored in the memory 30. The additional function module 200 according to the third example reads the detection result from the memory 30, and thus is able to detect the edge portion.

The printer system having the above configuration according to the third example can be made to have the same effect as the printer system according to the first example. In addition, it is possible to print the edge portion to be smooth when performing the ink-saving printing.

### D. MODIFIED EXAMPLES

The invention is not limited to the above-mentioned examples and embodiments, and may be modified in various forms without departing from the technical spirit of the invention. For example, the following modifications also can be applied.

### D1. Modified Example 1

In the above-mentioned examples, the additional function module 200 is disposed just behind the printer drivers 100a to 100c in the PC 10, but instead, it may be disposed at a random location in the rear of the printer drivers 100a to 100c. For example, the additional function module 200 may be disposed between the spooler 25 and the port monitor 26. Alternatively, the additional function module 200 may be disposed in the cable 52.

Specifically, the exemplary method of disposition of the additional function module 200 in the cable 52 is as follows: a CPU and a memory are mounted on any one of the connectors (not shown in the drawing) on both ends of the cable 52, and the CPU is configured to function as the additional function module 200. In this configuration, the additional function module 200 is not installed on the PC 10, and the PC 10 outputs the print data PDS, which is not subjected to the dot conversion processing, toward the printer PRTa. Then, in the connector of the cable 52, the additional function module 200 receives the print data PD5, performs the above-mentioned dot conversion processing, generates the print data FNL, and sends the print data FNL to the printer PRTa. The configuration of the modified example has the same effect of those of the above-mentioned examples. Furthermore, in the configuration, the additional function module 200 is not installed on the PC 10. Hence, it is possible to suppress illegitimate copies of the additional function module 200. Further, the ink-saving printing is not performed without the cable on which the additional function module 200 is installed. Hence, it is possible to restrict the number of clients capable of performing the ink-saving printing in accordance with the number of the cables. Furthermore, in the configuration, the cable on which the additional function module 200 is installed corresponds to the image processing device described in the claims.

### D2. Modified Example 2

In the above-mentioned examples, the additional function module 200 provides the image processing function for performing the ink-saving printing, but instead, it may provide an optional image processing function for printing. For example, in the second example, the large and medium light cyan (LC) dots are replaced with the small cyan (C) dots. However, the dots may be not replaced with dots of a different size but replaced with dots of different colored ink. In this case, it is possible to provide a function of adjusting the changes in hue of an image at the time of printing. Further, in the third example, the sizes of the dots at the edge portion are adjusted to the small size, but instead, the sizes of the dots at the edge portion may be adjusted to medium or large sizes. In this case, the ink-saving printing is not achieved, but it is possible to emphasize the edge. Furthermore, for example, in the second example, the small cyan (C) dots may be converted to large light cyan (LC) dots. That is, generally, an optional image processing function of processing the data (the dot data) corresponding to the image part subjected to a halftone processing may be applied to the image processing device according to the embodiment of the invention.

### D3. Modified Example 3

In the above-mentioned examples, the examples of the printer systems including the printers PRTa to PRTc have been described, but only configured from the PC 10 may be adopted. Specifically, in the PC 10, it may be possible to adopt a configuration in which the print data FNL is generated on the basis of the original image data ORG, and is not sent to the printers PRTa to PRTc with the print data FNL stored in the memory 30 or the hard disk drive 40. In this configuration, the print data FNL stored in the memory 30 or the hard disk drive 40 is moved to a storage medium such as a USB memory, and the storage medium is directly connected to the printers PRTa to PRTc, thereby performing so-called direct printing. As a result, it is possible to achieve ink-saving printing.

### D4. Modified Example 4

In the above-mentioned examples, the additional function module 200 performs the conversion processing of replacing the large and medium dots with the small dots, but the large dots may be replaced with the medium dots instead of the small dots. In addition, instead of performing the conversion processing on all the large and medium dots, the conversion processing can be performed only on the some of the dots (for example, dots near the edge of an image). That is, generally, in a configuration capable of printing dots which have a plurality of sizes, an optional configuration, in which at least some of the dots which are in the ON state are replaced with the smaller dots, may be applied to the image processing device according to the embodiment of the invention.

### D5. Modified Example 5

In the above-mentioned examples, the printers PRTa to PRTc are able to form dots having three sizes, but are not limited to the three sizes, and may be configured to be able to form dots having optional sizes.

### D6. Modified Example 6

In the above-mentioned examples, a part of the configuration realized by hardware may be replaced with software. On the other hand, a part of the configuration formed by software may be replaced with hardware.

In addition, a part or the whole of the function according to the embodiment of the invention may be realized by software. In this case, the software (a computer program) can be provided in a form whereby the software is stored on a computer-readable recording medium. In the invention, the “computer-readable recording medium” is not limited to portable recording media such as flexible disks and CD-ROMs, but is defined to include an internal storage device, such as various RAMs and ROMs, in a computer and an external storage device, such as a hard disk, fixed on the computer.

The entire disclosure of Japanese Patent Application No. 2008-205187, filed Aug. 8, 2008 is expressly incorporated by reference herein.

What is claimed is:

1. A print data generation method of generating print data, which is described by a predetermined printer description language and used in a predetermined printing apparatus, by using an image processing device, the method comprising:
receiving first print data, which is described by the predetermined printer description language and generated by a device driver used for printing of the printing apparatus, from the device driver; and
generating second print data, which is obtained by processing image correspondence data as data corresponding to at least portion of an image part of the received first print data.

2. The print data generation method according to claim 1,
wherein the printing apparatus is able to perform image formation by using dots of a plurality of sizes,
wherein the first print data includes data on the sizes of the dots assigned to pixels forming the image, and
wherein in the generating of the second print data, at least some of the dots of a predetermined size are replaced with dots of a size smaller than the predetermined size in the first print data.

3. The print data generation method according to claim 2,
wherein the printing apparatus is able to perform image formation by using dots of a first color and dots of a second color having a higher color density than the first color,
wherein the first print data includes data on the colors of the dots assigned to pixels forming the image, and
wherein in the generating of the second print data, at least some of the dots of the first color are replaced with the dots of the second color in the first print data.

4. The print data generation method according to claim 1,
wherein the printing apparatus is able to perform image formation by using dots of a first color and dots of a second color having a higher color density than the first color,
wherein the first print data includes data on the colors of the dots assigned to pixels forming the image, and
wherein in the generating of the second print data, at least some of the dots of the first color are replaced with the dots of the second color in the first print data.

5. The print data generation method according to claim 1,
wherein the printing apparatus is able to perform image formation by using dots of a plurality of sizes, and is able to perform image formation by using dots of a first color and dots of a second color having a higher color density than the first color,
wherein the first print data includes data on the sizes of the dots assigned to pixels forming the image, and data on the colors of the dots assigned to pixels forming the image, and
wherein in the generating of the second print data, at least some of the dots of the first color and of a predetermined size are replaced with dots of the second color and of a size smaller than the predetermined size in the first print data.

6. The print data generation method according to claim 1, further comprising:
acquiring information representing an edge portion of the image part from the first print data by using an edge information acquisition section,
wherein the printing apparatus is able to perform image formation by using dots of a plurality of sizes,
wherein the first print data includes data on the sizes of the dots assigned to pixels forming the image, and
wherein in the generating of the second print data, sizes of dots at the edge portion are made uniform in the first print data.

7. A medium storing a computer program for generating, in a computer, print data described by a predetermined printer description language and used in a predetermined printing apparatus, the computer program causing the computer to execute the functions of:
receiving first print data, which is described by the predetermined printer description language and generated by a device driver used for printing of the printing apparatus, from the device driver; and
generating second print data which is obtained by processing image correspondence data as data corresponding to at least portion of an image part of the received first print data.

8. The medium according to claim 7,
wherein the printing apparatus is able to perform image formation by using dots of a plurality of sizes,
wherein the first print data includes data on the sizes of the dots assigned to pixels forming the image, and
wherein the function of generating the second print data replaces at least some of the dots of a predetermined size with dots of a size smaller than the predetermined size in the first print data.

9. The medium according to claim 8,
wherein the printing apparatus is able to perform image formation by using dots of a first color and dots of a second color having higher color density than the first color,
wherein the first print data includes data on the colors of the dots assigned to pixels forming the image, and
wherein the function of generating the second print data replaces at least some of the dots of the first color with the dots of the second color in the first print data.

10. The medium according to claim 7,
wherein the printing apparatus is able to perform image formation by using dots of a first color and dots of a second color having a higher color density than the first color,
wherein the first print data includes data on the colors of the dots assigned to pixels forming the image, and
wherein the function of generating the second print data replaces at least some of the dots of the first color with the dots of the second color in the first print data.

11. The medium according to claim 7,
wherein the printing apparatus is able to perform image formation by using dots of a plurality of sizes, and is able to perform image formation by using dots of a first color and dots of a second color having a higher color density than the first color,
wherein the first print data includes data on the sizes of the dots assigned to pixels forming the image, and data on the colors of the dots assigned to pixels forming the image, and
wherein the function of generating the second print data replaces at least some of the dots of the first color and of a predetermined size with dots of the second color and of a size smaller than the predetermined size in the first print data.

12. The medium according to claim 7,
wherein the computer program causes the computer to execute an edge information acquisition function of acquiring information representing an edge portion of the image part from the first print data
wherein the printing apparatus is able to perform image formation by using dots of a plurality of sizes,
wherein the first print data includes data on the sizes of the dots assigned to pixels forming the image, and
wherein the function of generating the second print data makes sizes of dots at the edge portion uniform in the first print data.

13. An image processing device for generating print data, which is described by a predetermined printer description language and used in a predetermined printing apparatus, the image processing device comprising:
a reception section receiving first print data, which is described by the predetermined printer description language and generated by a device driver used for printing of the printing apparatus, from the device driver; and
a print data generation section generating second print data, which is obtained by processing image correspondence data as data corresponding to at least portion of an image part of the received first print data.

14. The image processing device according to claim 13,
wherein the printing apparatus is able to perform image formation by using dots of a plurality of sizes,
wherein the first print data includes data on the sizes of the dots assigned to pixels forming the image, and
wherein the print data generation section replaces at least some of the dots of a predetermined size with dots of a size smaller than the predetermined size in the first print data.

15. The image processing device according to claim 14,
wherein the printing apparatus is able to perform image formation by using dots of a first color having a plurality of sizes and by using dots of a second color having a plurality of sizes and having higher color density than the first color,
wherein the first print data includes data on the colors of the dots assigned to pixels forming the image, and
wherein the print data generation section replaces at least some of the dots of the first color with the dots of the second color in the first print data.

16. The image processing device according to claim 13,
wherein the printing apparatus is able to perform image formation by using dots of a first color having a plurality of sizes and by using dots of a second color having a plurality of sizes and having higher color density than the first color,
wherein the first print data includes data on the colors of the dots assigned to pixels forming the image, and
wherein the print data generation section replaces at least some of the dots of the first color with the dots of the second color in the first print data.

17. The image processing device according to claim 13,
wherein the printing apparatus is able to perform image formation by using dots of a plurality of sizes, and is able to perform image formation by using dots of a first color and dots of a second color having a higher color density than the first color,
wherein the first print data includes data on the sizes of the dots assigned to pixels forming the image, and data on the colors of the dots assigned to pixels forming the image, and
wherein the print data generation section replaces at least some of the dots of the first color and of a predetermined size with dots of the second color and of a size smaller than the predetermined size in the first print data.

18. The image processing device according to claim 13, further comprising:
an edge information acquisition section for acquiring information representing an edge portion of the image part from the first print data,
wherein the printing apparatus is able to perform image formation by using dots of a plurality of sizes,
wherein the first print data includes data on the sizes of the dots assigned to pixels forming the image, and
wherein the print data generation section makes sizes of dots at the edge portion uniform in the first print data.

19. The image processing device according to claim 13, further comprising:
the device driver,
wherein the reception section receives the first print data, which is generated by the device driver provided in the image processing device.
